(19) United States
(12) Patent Application Publication
(10) Pub. No.: US 2025/0303574 A1
(43) Pub. Date: Oct. 2, 2025

(54) MULTIMODAL ROBOT-HUMAN INTERACTION VIA TEXT, VOICE, AND VIDEO FOR ROBOT CONTROLS

(71) Applicant: Blue Hill Tech, Inc., Seattle, WA (US)

(72) Inventors: Meng Wang, Seattle, WA (US); Shuo Liu, Kirkland, WA (US); Tong Liu, Bothell, WA (US)

(73) Assignee: Blue Hill Tech, Inc., Seattle, WA (US)

(21) Appl. No.: 19/085,436

(22) Filed: Mar. 20, 2025

Related U.S. Application Data
(60) Provisional application No. 63/570,692, filed on Mar. 27, 2024.

(51) Int. Cl. B25J 9/16; B25J 13/00; B25J 19/02; G06V 40/16; G06V 40/20

(52) U.S. Cl. CPC B25J 9/1689; B25J 9/161; B25J 9/163; B25J 9/1666; B25J 13/003; B25J 19/023; G06V 40/172; G06V 40/28

(57) ABSTRACT

Disclosed are a system and method for multimodal robot-human interaction using hand gestures and facial recognition for automated service robots. The system includes a robotic system with an integrated camera for capturing visual data, enabling hand gesture recognition and facial profiling. A control module processes this data to identify gestures and facial profiles, facilitating real-time interaction and decision-making. The gesture recognition module interprets hand gestures to control the robotic system's operations, while the facial recognition module identifies customers for personalized interactions. A communication interface supports interaction via text, voice, and video. The system is further enhanced by sensors for improved accuracy and a display module for visual feedback. The method involves capturing and processing visual data, interpreting gestures, and executing predefined actions, thereby streamlining tasks such as order and confirmation processes.

### CROSS-REFERENCES TO RELATED APPLICATIONS

This application claims priority to U.S. Provisional Application No. 63/570,692 filed Mar. 27, 2024, which is incorporated in its entirety for all purposes.

### TECHNOLOGICAL FIELD

The present disclosure generally relates to automated service robots and more particularly relates to a system and method for multimodal robot-human interaction using hand gestures and facial recognition for automated service robots.

### BACKGROUND

In the field of automated service robots, effective interaction between humans and robots is crucial for enhancing user experience and operational efficiency. Traditional methods of interaction, such as text-based commands or simple voice recognition, often fall short of providing a seamless and intuitive user interface. The need for more natural and multimodal interaction methods has become increasingly apparent, particularly in environments where robots are expected to perform complex tasks and respond to dynamic human inputs.

Current technologies in face detection and hand gesture detection have been applied across various domains, including security, biometric authentication, and human-computer interaction. Face detection is widely used in facial recognition systems for security and access control, as well as in applications like emotion recognition and augmented reality. Hand gesture detection, on the other hand, facilitates human-computer interaction in virtual and augmented reality environments, sign language recognition, and gesture-controlled devices. These technologies have demonstrated the potential to enhance user interaction by providing more intuitive and natural interfaces.

Despite the advancements in face and hand gesture detection, existing solutions often face limitations in terms of accuracy, adaptability, and integration into complex systems. Many current systems struggle with real-time processing and recognition in diverse and dynamic environments, leading to inconsistent performance. Additionally, the integration of multiple modalities, such as combining facial and gesture recognition, remains a challenge due to the complexity of synchronizing and processing different data streams effectively.

Given these challenges, there is a significant need for a system that can seamlessly integrate multimodal interaction methods to improve robot-human interaction. The proposed present invention addresses these deficiencies by providing a system and method that leverages advancements in computer vision and machine learning to enhance the interaction capabilities of service robots.

Further limitations and disadvantages of conventional approaches will become apparent to one of skill in the art through the comparison of described systems with some aspects of the present disclosure, as outlined in the remainder of the present application and with reference to the drawings.

### BRIEF SUMMARY OF SOME EXAMPLE EMBODIMENTS

In order to solve the foregoing problem, the present disclosure may provide a system and method for multimodal robot-human interaction using hand gestures and facial recognition for automation.

In one aspect, a system for multimodal robot-human interaction using hand gestures and facial recognition for automated service robots is provided. The system includes a robotic system, a memory, a computer processor, a communication interface, and a plurality of sensors. The robotic system is equipped with a camera mounted on an automated service robot, preferably on the wrist of the automated service robot. The camera is configured to capture visual data for hand gesture recognition and facial profiling. The memory is operatively connected to the robotic system to store a set of program instructions pertaining to hand gesture recognition and facial profiling. The computer processor is coupled to the memory to execute the set of program instructions. The memory includes a control module, a gesture recognition module, and a facial recognition module. The control module processes the visual data to identify the hand gestures and the facial profiles of a user. The gesture recognition module interprets the hand gestures to control a set of operations of the robotic system, including pausing, resuming, and error handling. The facial recognition module identifies the user customers based on the facial profile and facilitates one or more personalized interactions. The communication interface enables interaction via one or more of text, voice, and video. The control module is configured to execute a set of predefined actions in response to recognized hand gestures and facial profiles, enabling real-time interaction and decision-making. The sensors are integrated with the robotic system to provide accurate hand gesture recognition and facial profiling.

In additional system embodiments, the gesture recognition module is configured to recognize a plurality of hand gestures. Each hand gesture is associated with a specific command for the robotic system, including an open hand for pausing, a thumbs up for resuming, and a fist for error handling.

In additional system embodiments, the facial recognition module is configured to access a database of customer profiles.

In additional system embodiments, the memory may include a display module operatively connected to the communication interface. The display module is configured to present visual feedback to users during interactions.

In additional system embodiments, the control module is configured to integrate hand gesture control and facial recognition to facilitate a quick order and confirmation process.

In additional system embodiments, the robotic system is configured to mimic human arm movements, providing the flexibility and dexterity necessary for handling various tasks.

In yet another aspect, a method for multimodal robot-human interaction using hand gestures and facial recognition for automated service robots is provided. The method includes a step of capturing, by a computer processor, visual data using a camera mounted on a robotic system. The method includes a step of processing, by the computer processor, the visual data to identify hand gestures and facial profiles. The method includes a step of interpreting, by the computer processor, and hand gestures to control a set of operations of the robotic system, including pausing, resuming, and error handling. The method includes a step of identifying, by the computer processor, the user customers based on the facial profiles to facilitate personalized interactions. The method includes a step of executing, by the computer processor, a set of predefined actions in response to recognized hand gestures and facial profiles, enabling real-time interaction and decision-making. The method includes a step of enabling, by the computer processor, interaction via one or more of text, voice, and video through a communication interface.

In additional method embodiments, the method includes a step of accessing, by the computer processor, a database of the customer profiles.

In additional method embodiments, the step of interpreting hand gestures includes a step of recognizing, by the computer processor, a plurality of gestures, each associated with a specific command for the robotic system, including an open hand for pausing, a thumbs up for resuming, and a fist for error handling.

In additional method embodiments, the method includes a step of integrating, by the computer processor, a hand gesture control, and a facial recognition to facilitate a quick order and confirmation process.

Accordingly, one advantage of the present invention is that it provides an improved user experience through a more intuitive interaction method, enhanced efficiency in operating the robotic system, and increased customer satisfaction through personalized interactions. The integration of hand gesture and facial recognition technologies allows for seamless and intuitive control of the robotic system, enhancing both user experience and operational efficiency.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described exemplary embodiments of the disclosure in general terms, reference will now be made to the accompanying drawings, which are not necessarily drawn to scale, and wherein:

FIG. 1 illustrates a block diagram showing an example architecture of a system for multimodal robot-human interaction using hand gestures and facial recognition for automated service robots, in accordance with one or more example embodiments.

FIG. 2 illustrates a perspective view of a camera positioned on the hand of an automated service robot, in accordance with one or more example embodiments.

FIG. 3 illustrates a flowchart of a method for multimodal robot-human interaction using hand gestures and facial recognition for automated service robots, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, and/or stored in accordance with embodiments of the present disclosure. Thus, the use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the scope of the present disclosure. Further, it is to be understood that the phraseology and terminology employed herein are for the description and should not be regarded as limiting. Any heading utilized within this description is for convenience only and has no legal or limiting effect.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a,” “an,” and “the” designate both the singular and the plural, unless expressly stated to designate the singular only.

The present invention relates to a system and method for multimodal robot-human interaction, specifically utilizing hand gesture and facial recognition technologies to enhance the functionality and user experience of automated service robots. This invention is designed to address the need for a more intuitive and less intimidating interaction system, improving the user experience for both operators and customers. The system employs visual features obtained from cameras to drive various robot behaviors, enabling a fully automated service robot to perform tasks such as serving drinks to customers.

A key aspect of the invention is the integration of hand gesture control and facial recognition, which allows for seamless and natural interaction between humans and robots. Hand gestures may be used to control the robot in situations requiring manual handling, such as when materials need refilling. The system may recognize specific gestures to pause, resume, or continue operations, thereby enhancing operational efficiency and reducing the need for complex interfaces. Additionally, the system may greet customers based on facial profiles, facilitating personalized interactions by identifying customers and responding both physically and verbally according to their order history.

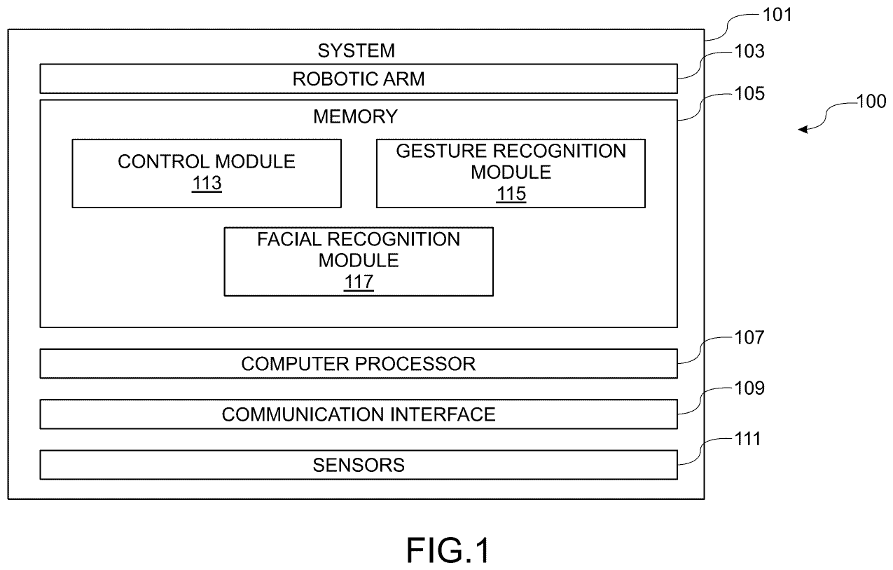

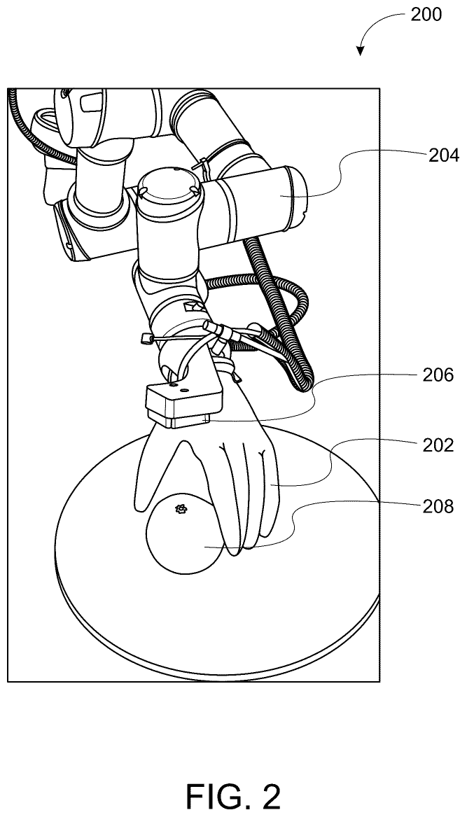

FIG. 1 illustrates a block diagram 100 showing an example architecture of a system 101 for multimodal robot-human interaction using hand gestures and facial recognition for automated service robots, in accordance with one or more example embodiments. The system 101 includes a robotic system 103, a memory 105, a computer processor 107, a communication interface 109, and a plurality of sensors 111. The robotic system 103 is equipped with a camera mounted on an automated service robot (shown in FIG. 2), preferably on the wrist of the automated service robot. The camera is configured to capture visual data for hand gesture recognition and facial profiling. Memory 105 is operatively connected to the robotic system 103 to store a set of program instructions pertaining to hand gesture recognition and facial profiling. The computer processor 107 is coupled to the memory 105 to execute the set of program instructions. Memory 105 includes a control module 113, a gesture recognition module 115, and a facial recognition module 117.

The control module 113 processes the visual data to identify the hand gestures and the facial profiles of a user. The gesture recognition module 115 interprets the hand gestures to control a set of operations of the robotic system 103, including pausing, resuming, and error handling. The gesture recognition module 115 is configured to recognize a plurality of hand gestures. Each hand gesture is associated with a specific command for the robotic system 103, including an open hand for pausing, a thumbs up for resuming, and a fist for error handling. The facial recognition module 117 identifies the user customers based on the facial profile and facilitates one or more personalized interactions. In an embodiment, the facial recognition module 117 is configured to access a database of customer profiles. The communication interface 109 enables interaction via one or more of text, voice, and video. The control module 113 is configured to execute a set of predefined actions in response to recognized hand gestures and facial profiles, enabling real-time interaction and decision-making. The sensors 111 are integrated with the robotic system 103 to provide accurate hand gesture recognition and facial profiling. In an embodiment, the memory 105 may include a display module operatively connected to the communication interface 109. The display module is configured to present visual feedback to users during interactions. In an embodiment, the control module 113 is configured to integrate hand gesture control and facial recognition to facilitate a quick order and confirmation process. In an embodiment, the robotic system 103 is configured to mimic human arm movements, providing the flexibility and dexterity necessary for handling various tasks. In an embodiment, the robotic system 103 includes a robotic arm, a humanoid robot, and a service robot with a set of mobility features. In an embodiment, the robotic system 103 is configured to integrate hand gesture control and facial recognition to facilitate a quick order and confirmation process.

According to some embodiments, each of the components and modules 113-117 may be embodied in memory 105. The computer processor 107 may retrieve computer program code instructions that may be stored in memory 105 for the execution of computer program code instructions, which may be configured to facilitate data-driven decisions and achieve optimal marketing outcomes.

The computer processor 107 may be embodied in a number of different ways. For example, the computer processor 107 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field-programmable gate array), a microcontroller unit (MCU), a hardware accelerator, a special-purpose computer chip, or the like. As such, in some embodiments, the computer processor 203 may include one or more processing cores configured to perform independently. A multi-core processor may enable multiprocessing within a single physical package. Additionally, or alternatively, the computer processor 107 may include one or more processors configured in tandem via the bus to enable independent execution of instructions, pipelining, and/or multithreading.

Additionally, or alternatively, the computer processor 107 may include one or more processors capable of processing large volumes of workloads and operations to provide support for big data analysis. In an example embodiment, the computer processor 107 may be in communication with the memory 105 via a bus for passing information to system 101. Memory 105 may be non-transitory and may include, for example, one or more volatile and/or non-volatile memories. In other words, for example, the memory 105 may be an electronic storage device (for example, a computer-readable storage medium) comprising gates configured to store data (for example, bits) that may be retrievable by a machine (for example, a computing device like the computer processor 107). The memory 105 may be configured to store information, data, content, applications, instructions, or the like, to enable the computer processor 107 to carry out various functions in accordance with an example embodiment of the present disclosure. For example, memory 105 may be configured to buffer input data for processing by the computer processor 107. As exemplified in FIG. 1, the memory 105 may be configured to store instructions for execution by the computer processor 107. As such, whether configured by hardware or software methods, or by a combination thereof, the computer processor 107 may represent an entity (for example, physically embodied in circuitry) capable of performing operations according to an embodiment of the present disclosure while configured accordingly. Thus, for example, when the computer processor 107 is embodied as an ASIC, FPGA, or the like, the computer processor 107 may be specifically configured hardware for conducting the operations described herein. Alternatively, as another example, when the computer processor 107 is embodied as an executor of software instructions, the instructions may specifically configure the computer processor 107 to perform the algorithms and/or operations described herein when the instructions are executed. However, in some cases, the computer processor 107 may be a processor-specific device (for example, a mobile terminal or a fixed computing device) configured to employ an embodiment of the present disclosure by further configuration of the computer processor 107 by instructions for performing the algorithms and/or operations described herein. The computer processor 107 may include, among other things, a clock, an arithmetic logic unit (ALU), and logic gates configured to support the operation of the computer processor 107.

The system 101 may be accessed using the communication interface 109 or a user interface. The communication interface 109 may provide an interface for accessing various features and data stored in the system 101. For example, the communication interface 109 may comprise an I/O interface which may be in the form of a GUI, a touch interface, a voice-enabled interface, a keypad, and the like. In an embodiment, the communication interface 109 may present visual reports or dashboards based on insights and forecasts.

FIG. 2 illustrates a perspective view 200 of a camera positioned on robotic hand 202 of an automated service robot 204, in accordance with one or more example embodiments. FIG. 2 is explained in conjunction with the elements of FIG. 1. The robotic system 103 is equipped with a camera 206 mounted on the wrist, configured to facilitate multimodal robot-human interaction through hand gestures and facial recognition. The camera 206 is strategically positioned to center the image on the object 208 held by the robotic hand, allowing for precise visual input necessary for the system's operation. The robotic hand 202 is shown wearing a glove, which is compatible with the camera's 206 positioning to ensure that the robotic system 103 functions effectively without interference from the glove material.

In one embodiment of the present invention, the camera 206 is mounted on the wrist of the robotic system serves as a critical component for capturing visual data necessary for both hand gesture recognition and facial profiling. The camera's orientation and positioning allow it to capture a wide field of view, enabling the robotic system to detect and interpret various hand gestures made by human operators. This capability is essential for executing commands such as pausing, resuming, or overriding current operations, thereby enhancing the system's responsiveness and adaptability in dynamic service environments.

Additionally, the robotic hand 202, as depicted in FIG. 2, is designed to interact with customers by utilizing the camera for facial recognition. This feature allows the system to identify customers based on their facial profiles, facilitating personalized interactions such as greeting customers by name and recommending products based on their order history. The integration of facial recognition technology into the robotic system's functionality not only improves customer engagement but also streamlines the service process by enabling quick order confirmations and personalized service delivery.

In an embodiment, the camera 202 is mounted on at least one of: a wrist of the robotic system, a head of a humanoid robot, and an external stationary position within an operating environment. In an embodiment, the camera 202 mounted on the wrist provides a close-range view of a set of objects held by the robotic system 103. In some embodiments, the wrist-mounted camera provides significant advantages for close-range object detection by ensuring a consistent field of view that closely aligns with the user's hand movements. This positioning allows for precise tracking of fine motor actions, improving the accuracy of object interaction recognition in cluttered or dynamic environments. Furthermore, the wrist-mounted camera is designed to be fully compatible with motion-capturing gloves to provide seamless integration with human demonstrations for data collection. This compatibility ensures that both the camera and gloves work in synchronization, capturing real-time hand movements and object interactions with high fidelity. In an embodiment, the camera 202 is mounted on head of the humanoid robot enables wide-angle human interaction and environment awareness. In an embodiment, the robotic system's 103 robotic hand 202 is configured to be compatible with human-like gloves while maintaining effective gesture recognition and object manipulation.

According to an embodiment herein, the robotic system 103 is trained through a three-phase training process comprising a data collection phase, a model training phase, and a deployment phase.

In the data collection phase, human demonstrations and teleoperation methods are utilized. Human demonstrations involve the use of motion-capturing devices, such as data gloves or cameras, to track the precise actions of each finger. Additionally, existing videos from online sources or offline training materials provided by businesses are used to train the model. The human demonstrator manipulates objects and operates tools directly while the system records the demonstrator's actions and interactions with the objects and tools. Thus, in the human demonstration method, operators perform actions while equipped with sensors such as cameras, positional trackers, and pressure/tactile sensors. These recordings capture real-world movements and object interactions, allowing the robot to observe and learn from human behavior.

Teleoperation involves a human operator using a motion-capturing device to control the robotic system. The robotic system records the robot's actions and interactions with objects and tools while capturing both input commands and system responses for training and refinement. Thus, in the teleoperation method, human operators directly control the robot, guiding its movements and actions while the system records the data for training. For example, an operator might demonstrate how to pick up a fragile object, such as a glass, while wearing motion-tracking gloves. The system records the force applied, the grasping technique, and the object's response, ensuring that the robot learns how to handle delicate items safely.

In the model training phase, AI models learn object interaction and behavior recognition based on the collected data. The training process can be enhanced with human supervision through video annotation, where operators highlight or mask objects in the video feed to improve object recognition, or text-based inputs, where specific instructions refine the learning process. For instance, while training the robot for dishwashing, a human supervisor can mark sponges as “soft grip” and ceramic plates as “firm grip” in the training dataset. This allows the robot to adapt its force depending on the object it is handling.

In the deployment phase, the trained AI model autonomously executes tasks and adapts to environmental variables, enabling improved robotic performance in various operational environments. In this final phase, the robot continuously receives real-time data from its cameras and sensors, which is processed by the trained model to generate trajectory and action data. These outputs are then converted into precise robot movement commands, enabling seamless and autonomous operation. For example, in a restaurant setting, the robot can navigate between tables, detect plates needing collection, and transport them to the kitchen while avoiding obstacles. The aforementioned training approach enables the automated service robot 204 to perform complex tasks with high accuracy, adaptability, and minimal human intervention. This method ensures that the robot operates efficiently in dynamic environments, making it suitable for various service applications.

The system further comprises a modular design that allows for the integration of additional sensors and components as needed. This flexibility ensures that the robotic system can be customized to meet the specific requirements of different service environments, such as cafes, restaurants, or retail settings. The use of durable materials for the robotic system and camera housing ensures longevity and reliability, even in high-traffic service areas.

In accordance with yet another embodiment, the robotic system's ability to recognize and respond to hand gestures significantly reduces the need for manual intervention, allowing operators to control the system intuitively. This feature is particularly beneficial in scenarios where quick decision-making is required, such as during peak service hours or when handling multiple customer interactions simultaneously. The system's ability to autonomously interpret and execute commands based on visual input enhances operational efficiency and reduces the likelihood of errors, ultimately leading to a more seamless and satisfying customer experience. The robotic system is trained to differentiate between a set of object categories based on a plurality of parameters comprising a location, appearance, and characteristics learned during the human demonstration. Further, the automated service robot is configured to navigate the environment autonomously to avoid one or more obstacles while executing a task, by utilizing one or more of a visual sensor, a positional sensor, and a depth sensor.

According to an embodiment herein, the system's adaptability is further exemplified by its ability to integrate with existing service infrastructure, allowing for seamless deployment in various environments. An embodiment of the present invention may include the capability to interface with point-of-sale systems, inventory management software, and customer relationship management tools, thereby enhancing the overall service delivery process. This integration ensures that the robotic system can operate in harmony with other technological solutions, providing a cohesive and efficient service experience.

In another embodiment, the system may be configured to learn and adapt to user preferences over time. By analyzing data collected through interactions, the system can refine its responses and recommendations, offering a more personalized service to repeat customers. This adaptive learning capability not only improves customer satisfaction but also fosters loyalty by creating a more tailored and engaging experience.

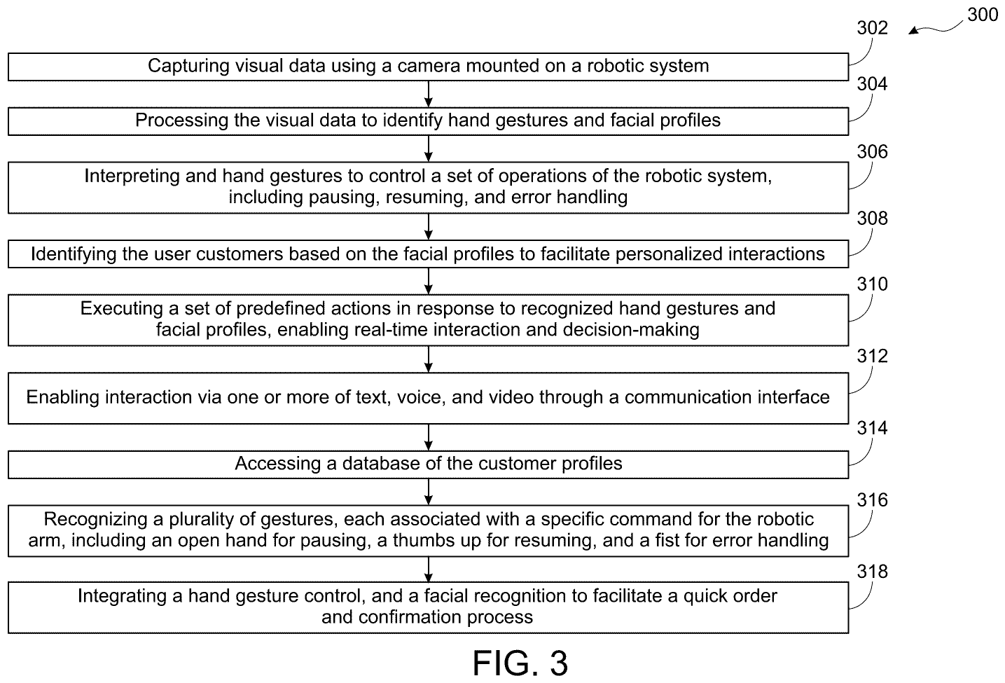

FIG. 3 illustrates a flowchart of a method 300 for multimodal robot-human interaction using hand gestures and facial recognition for automated service robots, in accordance with one or more example embodiments. FIG. 3 is explained in conjunction with the elements of FIGS. 1-2. Method 300 includes a step 302 of capturing, by a computer processor, visual data using a camera mounted on a robotic system. Method 300 includes a step 304 of processing, by the computer processor, the visual data to identify hand gestures and facial profiles. Method 300 includes a step 306 of interpreting, by the computer processor, and hand gestures to control a set of operations of the robotic system, including pausing, resuming, and error handling. Method 300 includes step 308 of identifying, by the computer processor, the user customers based on the facial profiles to facilitate personalized interactions. The method 300 includes a step 310 of executing, by the computer processor, a set of predefined actions in response to recognized hand gestures and facial profiles, enabling real-time interaction and decision-making. The method 300 includes a step 312 of enabling, by the computer processor, interaction via one or more of text, voice, and video through a communication interface. In additional method embodiments, the method 300 includes a step 314 of accessing, by the computer processor, a database of the customer profiles. In additional method embodiments, the step 306 of interpreting hand gestures includes a step 316 of recognizing, by the computer processor, a plurality of gestures, each associated with a specific command for the robotic system, including an open hand for pausing, a thumbs up for resuming, and a fist for error handling. In additional method embodiments, the method 300 includes a step 318 of integrating, by the computer processor, a hand gesture control, and a facial recognition to facilitate a quick order and confirmation process.

According to an embodiment herein, the automated service robot is configured to receive instructions from users or human operators through one or more of: voice commands or text commands to repeat actions and execute tasks with precision. The automated service robot is equipped with cameras and microphones to observe human demonstrations and process detailed instructions in real time.

In operation, the automated service robot learns tasks through demonstrations provided by human operators, which include: (1) capturing the actions and gestures of the human demonstrator, (2) identifying the location, appearance, and characteristics of relevant objects (e.g., apples, oranges, knives, cups) and appliances (e.g., coffee machines, stoves, ice machines), (3) analyzing interactions between the demonstrator and the objects or appliances, and (4) processing verbal instructions provided by the demonstrator.

Once the demonstration is completed, the human operator can instruct the automated service robot to replicate specific actions or execute the entire task autonomously. During execution, the automated service robot remains responsive to real-time operator input to allow the operator to pause actions through gestures or voice commands and modify the task by adding additional steps via voice instructions or further demonstrations. This functionality ensures dynamic task adaptation and improves the automated service robot's ability to perform complex, multi-step operations in real-world environments. The robotic system is trained to differentiate between a set of object categories including food items, kitchen utensils, and appliances, based on their location, appearance, and characteristics learned during human demonstrations.

Accordingly, one of the various advantages of the present invention is that it can enhance user experience through intuitive interaction methods, such as hand gestures and facial recognition. These technical features enable the system to operate efficiently, reducing the need for complex interfaces and manual intervention. The result is a more natural and engaging interaction between humans and robots, which improves both operator productivity and customer satisfaction. The system's modular design and adaptability further contribute to its versatility, making it suitable for a wide range of applications across different industries.

Thus, the present invention provides a comprehensive solution for multimodal robot-human interaction, leveraging advanced technologies to create a more intuitive, efficient, and customer-centric service experience. By addressing the challenges associated with traditional robotic systems, the invention sets a new standard for automated service robots, offering significant advantages in terms of user engagement, operational efficiency, and adaptability to diverse service environments.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for multimodal robot-human interaction, comprising:
a robotic system equipped with a camera mounted on an automated service robot, wherein the camera is configured to capture visual data for a hand gesture recognition and a facial profiling;
a memory operatively connected to the robotic system to store a set of program instructions pertaining to the hand gesture recognition and the facial profiling;
a computer processor coupled to the memory to execute the set of program instructions, wherein memory comprises:
a control module to process the visual data to identify the hand gestures and the facial profiles of a user;
a gesture recognition module to interpret the hand gestures to control a set of operations of the robotic system; and
a facial recognition module to identify the user based on the facial profile and facilitate one or more personalized interactions; and
a communication interface to enable interaction via one or more of: text, voice, and video, wherein the control module is configured to execute a set of predefined actions in response to recognized hand gestures and facial profiles.

2. The system as claimed in claim 1, wherein the robotic system is selected from one or more of:
a robotic arm;
a humanoid robot; and
a service robot with a set of mobility features.

3. The system as claimed in claim 1, wherein the camera is mounted on at least one of: a wrist of the robotic system, a head of a humanoid robot, and an external stationary position within an operating environment.

4. The system as claimed in claim 3, wherein the camera mounted on the wrist provides a close-range view of a set of objects held by the robotic system.

5. The system as claimed in claim 3, wherein the camera mounted on head of the humanoid robot enables wide-angle human interaction and environment awareness.

6. The system as claimed in claim 1, wherein the robotic system's hand is configured to be compatible with human-like gloves while maintaining effective gesture recognition and object manipulation.

7. The system as claimed in claim 1, wherein the robotic system is configured to integrate hand gesture control and facial recognition to facilitate a quick order and confirmation process.

8. The system as claimed in claim 1, wherein the robotic system is trained through a three-phase training process comprising:
a data collection phase in which training data is captured using a human demonstration method and a teleoperation method;
a model training phase where a set of AI models learn object interaction and behavior recognition; and
a deployment phase where the trained AI model autonomously executes tasks and adapts to environmental variables.

9. The system as claimed in claim 1, wherein the robotic system is configured to receive a set of instructions from the user through one or more of:
a set of voice commands;
a set of text commands; and
a set of gesture-based inputs to repeat learned actions.

10. The system as claimed in claim 1, wherein the robotic system is configured to navigate the environment autonomously to avoid one or more obstacles while executing a task, by utilizing one or more of a visual sensor, a positional sensor, and a depth sensor.

11. The system as claimed in claim 1, comprising a plurality of sensors integrated with the robotic system, wherein the sensors are configured to provide an accurate hand gesture recognition and facial profiling.

12. The system as claimed in claim 1, wherein the gesture recognition module is configured to recognize a plurality of hand gestures, wherein each hand gesture is associated with a specific command for the robotic arm.

13. The system as claimed in claim 1, wherein the facial recognition module is configured to access a database of customer profiles.

14. The system as claimed in claim 1, wherein the control module is configured to integrate a hand gesture control and facial recognition to facilitate a quick order and confirmation process.

15. The system as claimed in claim 2, wherein the robotic arm is configured to mimic human arm movements.

16. The system as claimed in claim 1, wherein the robotic system is trained to differentiate between a set of object categories based on a plurality of parameters comprising a location, appearance, and characteristics learned during the human demonstration.

17. The system as claimed in claim 1, wherein the automated service robot is configured to navigate the environment autonomously to avoid one or more obstacles while executing a task, by utilizing one or more of a visual sensor, a positional sensor, and a depth sensor.

18. A method for multimodal robot-human interaction, comprising:
capturing, by a computer processor, visual data using a camera mounted on a robotic system;
processing, by the computer processor, the visual data to identify hand gestures and facial profiles;
interpreting, by the computer processor, hand gestures to control a set of operations of the roboticsystem;
identifying, by the computer processor, the user based on the facial profiles to facilitate personalized interactions;
executing, by the computer processor, a set of predefined actions in response to recognized hand gestures and facial profiles; and
enabling, by the computer processor, interaction via one or more of text, voice, and video through a communication interface.

19. The method as claimed in claim 18, further comprising accessing, by the computer processor, a database of the customer profiles.

20. The method as claimed in claim 18, wherein the step of interpreting hand gestures comprising: recognizing, by the computer processor, a plurality of gestures, each associated with a specific command for the robotic system.

21. The method as claimed in claim 18, further comprising integrating, by the computer processor, a hand gesture control, and a facial recognition to facilitate a quick order and confirmation process.
